(19) United States
(12) Patent Application Publication
(10) Pub. No.: US 2021/0021571 A1
(43) Pub. Date: Jan. 21, 2021

(54) VEHICULAR FIREWALL PROVISION DEVICE

(71) Applicant: LG Electronics Inc., Seoul (KR)

(72) Inventors: Youngil KIM, Seoul (KR); Junsang PARK, Seoul (KR)

(21) Appl. No.: 16/930,758

(22) Filed: Jul. 16, 2020

(30) Foreign Application Priority Data
Jul. 16, 2019 (KR) 10-2019-0085476

(51) Int. Cl. H04L 29/06; G06F 21/60

(52) U.S. Cl. CPC H04L 63/0236; H04L 63/0263; H04L 63/101; G06F 21/602

(57) ABSTRACT

A vehicular firewall provision device includes a processor configured to match a data packet received from an external device and a plurality of rules, to temporally store log data of a plurality of data packets that are dropped according to at least one of the plurality of rules when data throughput of at least one electronic device included in a vehicle is equal to or greater than a reference value, and to encrypt the log data that are temporally stored when the data throughput is less than the reference value. In some examples, one or more of an autonomous vehicle, a user terminal, and a server are associated with a device related to an artificial intelligence module, an unmanned aerial vehicle (UAV), a robot, an augmented reality (AR) device, a virtual reality (VR) device, a 5G service, or the like.

### CROSS-REFERENCE TO RELATED APPLICATION

This application claims the benefit of priority to Korean Application No. 10-2019-0085476, filed on Jul. 16, 2019, the disclosure of which is hereby incorporated by reference in its entirety.

### TECHNICAL FIELD

The present disclosure relates to a vehicular firewall provision device.

### BACKGROUND

A vehicle is an apparatus that is moved in a desired direction by a user who rides therein. A representative example of a vehicle is an automobile. An autonomous vehicle is a vehicle that autonomously travels without driving manipulation of a human.

A communication device of an autonomous vehicle exchanges a data packet with an external device (e.g., a server or other vehicles). When data is exchanged, there may be hacking attack. To this end, a vehicle requires a firewall provision device.

When specific information is logged according to a vehicular firewall rule, the logged data needs to be encrypted. Rule information is recognized from log information, and thus log may be an attack point. However, loads due to logging and encryption may affect performance of a firewall and performance of AP/Modem with the firewall installed therein.

### SUMMARY

It is an object of the present disclosure to provide a vehicular firewall provision device for adjusting an encryption time point depending on a vehicle state.

The technical problems solved by the embodiments are not limited to the above technical problems, and other technical problems which are not described herein will become apparent to those skilled in the art from the following description.

In accordance with the present disclosure, the above and other objects can be accomplished by the provision of a processor configured to match a data packet received from an external device and a plurality of rules, to temporally store a plurality of pieces of log data of a plurality of data packets that are dropped according to at least one of the plurality of rules when data throughput of at least one electronic device included in a vehicle is equal to or greater than a reference value, and to encrypt the plurality of pieces of log data that are temporally stored when the data throughput is less than the reference value.

Details of other embodiments are included in a detailed description and drawings.

According to the above technical solution, the present disclosure may provide one or more of the following effects.

Safe logging may be ensured while a burden on a vehicle due to logging and encryption is minimized.

The effects of the present disclosure are not limited to the above-described effects and other effects which are not described herein may be derived by those skilled in the art from the following description of the embodiments of the disclosure.

### BRIEF DESCRIPTION OF THE DRAWINGS

FIG. 1 is a diagram showing an outer appearance of a vehicle according to an embodiment of the present disclosure.

FIG. 2 is a control block diagram of a vehicle according to an embodiment of the present disclosure.

FIG. 3 is a control block diagram of an electronic device according to an embodiment of the present disclosure.

FIG. 4 is a diagram for explanation of a vehicular firewall provision device according to an embodiment of the present disclosure.

FIG. 5 is a diagram for explanation of an operation of a vehicular firewall provision device according to an embodiment of the present disclosure.

FIGS. 6 and 7 are diagrams for explanation of an operation of a vehicular firewall provision device according to an embodiment of the present disclosure.

### DETAILED DESCRIPTION

Reference will now be made in detail to the exemplary embodiments of the present disclosure, examples of which are illustrated in the accompanying drawings. The suffixes “module” and “unit” of elements herein are used for convenience of description and thus can be used interchangeably, and do not have any distinguishable meanings or functions. In the following description of the at least one embodiment, a detailed description of known functions and configurations incorporated herein will be omitted for the purpose of clarity and for brevity. The features of the present disclosure will be more clearly understood from the accompanying drawings and should not be limited by the accompanying drawings, and it is to be appreciated that all changes, equivalents, and substitutes that do not depart from the spirit and technical scope of the present disclosure are encompassed in the present disclosure.

It will be understood that, although the terms “first”, “second”, “third” etc. may be used herein to describe various elements, these elements should not be limited by these terms.

These terms are only used to distinguish one element from another element.

It will be understood that when an element is referred to as being “on”, “connected to” or “coupled to” another element, it may be directly on, connected or coupled to the other element, or intervening elements may be present. In contrast, when an element is referred to as being “directly on,” “directly connected to” or “directly coupled to” another element or layer, there are no intervening elements present.

The singular expressions in the present specification include the plural expressions unless clearly specified otherwise in context.

It will be further understood that the terms “comprises” or “comprising” when used in this specification specify the presence of stated features, integers, steps, operations, elements, or components, but do not preclude the presence or addition of one or more other features, integers, steps, operations, elements, components, or groups thereof.

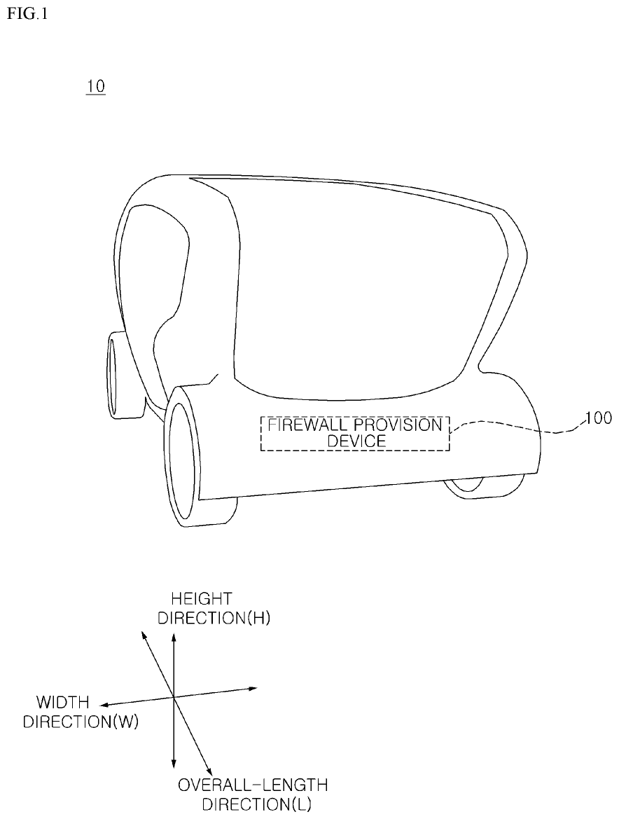

FIG. 1 is a diagram showing a vehicle according to an embodiment of the present disclosure.

Referring to FIG. 1, a vehicle 10 according to an embodiment of the present disclosure may be defined as a transportation device that travels on a road or a railroad. The vehicle 10 may conceptually include an automobile, a train, and a motorcycle. The vehicle 10 may include a vehicle equipped with an internal combustion engine as a power source, a hybrid vehicle equipped with both an engine and an electric motor as a power source, and an electric vehicle equipped with an electric motor as a power source. The vehicle 10 may be a sharing vehicle. The vehicle 10 may be an autonomous vehicle.

The vehicle 10 may include a firewall provision device 100.

The vehicle 10 may interact with at least one robot. The robot may be an autonomous mobile robot (AMR) that autonomously travels. The AMR is autonomously moveable and freely moves, and includes a plurality of sensors for avoiding an obstacle or the like while traveling. The AMR may be a flight type robot (e.g., a drone) including a flight device. The AMR may be a wheel type robot that includes at least one wheel and moves via rotation of the wheel. The AMR may be a leg type robot that includes at least one leg and moves using the leg.

A robot may function as a device for providing convenience of a user of the vehicle 10. For example, the robot may move a load on the vehicle 10 to a final destination of a user. For example, the robot may guide a road to a final destination to the user who exits from the vehicle 10. For example, the robot may transfer a user who exits from the vehicle 10 to a final destination.

At least one electronic device included in a vehicle may communicate with a robot through a communication device 220.

At least one electronic device included in a vehicle may provide, to the robot, data processed by at least one electronic device included in the vehicle. For example, the at least one electronic device included in the vehicle may provide, to the robot, at least one of object data, HD map data, vehicle state data, vehicle position data, or driving plan data.

The at least one electronic device included in the vehicle may receive data processed by the robot, from the robot. The at least one electronic device included in the vehicle may receive at least one of sensing data generated by the robot, object data, robot state data, robot position data, or robot moving plan data.

The at least one electronic device included in the vehicle may generate a control signal in further consideration of the data received from the robot. For example, the at least one electronic device included in the vehicle may compare information on an object generated by an object detection device 210 with information on an object generated by a robot and may generate a control signal based on the comparison result. The at least one electronic device included in the vehicle may generate a control signal to prevent interference between a moving route of the vehicle 10 and a moving route of the robot.

The at least one electronic device included in the vehicle may include a software module or a hardware module (hereinafter, an AI module) which implements artificial intelligence (AI). The at least one electronic device included in the vehicle may input the acquired data to the AI module and may use data output from the AI module.

The AI module may perform machine learning on input data using at least one artificial neural network (ANN). The AI module may output the driving plan data by performing machine learning on the input data.

The at least one electronic device included in the vehicle may generate a control signal based on the data output from the AI module.

In some embodiments, the at least one electronic device included in the vehicle may receive data processed by AI from an external device through the communication device 220. The at least one electronic device included in the vehicle may generate a control signal based on the data processed by AI.

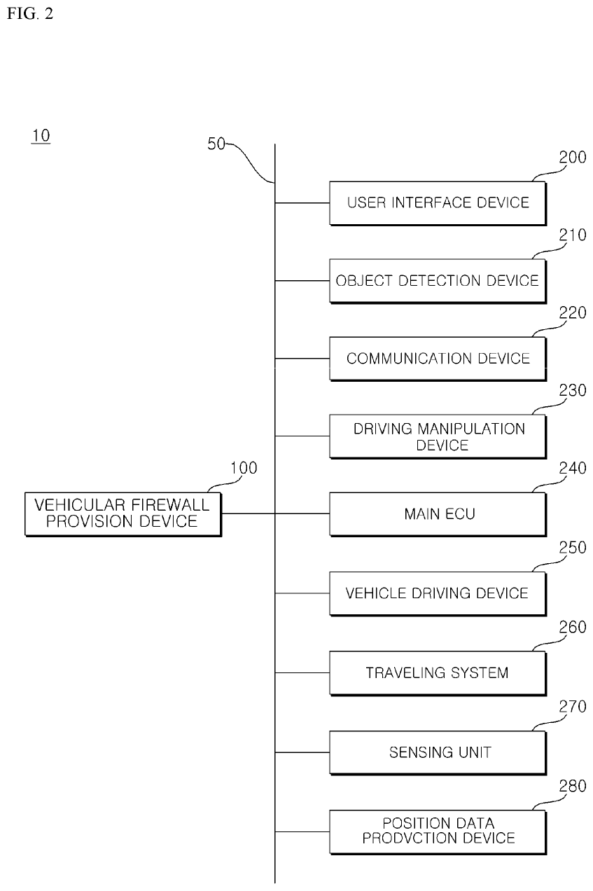

FIG. 2 is a control block diagram of a vehicle according to an embodiment of the present disclosure.

Referring to FIG. 2, the vehicle 10 may include the vehicular firewall provision device 100, a user interface device 200, an object detection device 210, a communication device 220, a driving manipulation device 230, a main electronic control unit (ECU) 240, a vehicle driving device 250, a traveling system 260, a sensing unit 270, and a position data generating device 280.

The vehicular firewall provision device 100 may be understood as an electronic device included in the vehicle 10. The vehicular firewall provision device 100 may be classified as a lower-ranking component of the communication device 220. In some embodiments, the vehicular firewall provision device 100 may be separately configured from the communication device 220. The vehicular firewall provision device 100 may be implemented by installing software in a processor.

The UI device 200 may be used to enable the vehicle 10 to communicate with a user. The UI device 200 may receive user input, and may provide information generated by the vehicle 10 to the user. The vehicle 10 may implement a UI or User Experience (UX) through the UI device 200. The user interface device 200 may be implemented as a display device installed in the vehicle 10, a head up display (HUD) device, a window display device, a cluster device, or the like. The user interface device 200 may include an input device, an output device, and a user monitoring device. The user interface device 200 may include an input device such as a touch input device, a mechanical input device, a voice input device, or a gesture input device. The user interface device 200 may include an output device such as a speaker, a display, or a haptic module. The user interface device 200 may include a user monitoring device such as a driver monitoring system (DMS) or an internal monitoring system (IMS).

The object detection device 210 may detect an object outside the vehicle 10. The object detection device 210 may include at least one sensor for detecting an object outside the vehicle 10. The object detection device 210 may include at least one of a camera, radio detecting and ranging (radar), light detection and ranging (LiDAR), an ultrasonic sensor, or an infrared sensor. The object detection device 210 may provide data of an object, which is generated based on a sensing signal generated by a sensor, to at least one electronic device included in a vehicle.

The camera may generate information on an object outside the vehicle 10 using an image. The camera may include at least one lens, at least one image sensor, and at least one processor that is condutibly connected to the image sensor to process a received signal and generates data of an object based on the processed signal.

The camera may be at least one of a mono camera, a stereo camera, or an around view monitoring (AVM) camera. The camera may acquire information about the location of an object, information about a distance to the object, or information about a relative speed with respect to the object by any of various image processing algorithms. For example, the camera may acquire information about a distance to an object and information about a relative speed with respect to the object in an acquired image, based on a variation in the size of the object over time. For example, the camera may acquire information about a distance to an object and information about a relative speed with respect to the object through a pin hole model, road surface profiling, or the like. For example, the camera may acquire information about a distance to an object and information about a relative speed with respect to the object based on disparity information in a stereo image acquired by a stereo camera.

To acquire an image of the exterior of the vehicle, the camera may be installed to ensure a field of view (FOV) in the vehicle. To acquire an image of the front view of the vehicle, the camera may be disposed in the vicinity of a front windshield inside the vehicle. Alternatively, the camera may be disposed around a front bumper or a radiator grille. To acquire an image of what lies behind the vehicle, the camera may be disposed in the vicinity of a rear glass inside the vehicle. Alternatively, the camera may be disposed around a rear bumper, a trunk, or a tail gate. To acquire an image of what lies on a side of the vehicle, the camera may be disposed in the vicinity of at least one of side windows inside the vehicle. Alternatively, the camera may be disposed around a side view mirror, a fender, or a door.

The RADAR may generate information an object outside the vehicle 10 using an electromagnetic wave. The RADAR may include an electromagnetic wave transmitter, an electromagnetic wave receiver, and at least one processor that is electrically connected to the electromagnetic wave transmitter and the electromagnetic wave receiver, is configured to a received signal, and to generate data of an object based on the processed signal. The RADAR may be implemented by pulse RADAR or continuous wave RADAR according to a radio wave emission principle. The RADAR may be implemented by Frequency Modulated Continuous Wave (FMCW) or Frequency Shift Keying (FSK) according to a signal waveform among the continuous wave radar methods. The RADAR may detect an object in a time of flight (TOF) or phase shifting by electromagnetic waves, and may detect the location, distance, and relative speed of the detected object. The RADAR may be disposed at an appropriate position on the exterior of the vehicle in order to sense an object ahead of, behind, or on a side of the vehicle.

The LiDAR may generate information on an object outside the vehicle 10 using a laser beam. The LiDAR may include an optical transmitter, an optical receiver, and at least one processor that is electrically connected to the optical transmitter and the optical receiver to process a received signal and generates data of an object based on the processed signal. The LiDAR may be implemented using a time of flight (TOF) method or a phase-shift method. The LiDAR may be implemented in a driven or non-driven manner. If the LiDAR is implemented in the driven manner, the LiDAR may be rotated by a motor and detect an object around the vehicle. If the LiDAR is implemented in a non-driven manner, the LiDAR may detect an object within a predetermined range from the vehicle by optical steering. The vehicle may include a plurality of non-driven LiDARs. The LiDAR may detect an object in TOF or phase shifting by laser light, and determine the location, distance, and relative speed of the detected object. The LiDAR may be disposed at an appropriate position on the exterior of the vehicle in order to sense an object ahead of, behind, or on a side of the vehicle.

The communication device 220 may exchange a signal with a device positioned outside the vehicle 10. The communication device 220 may exchange a signal with at least one of an infrastructure element (e.g., a server or a broadcasting station) or other vehicles. The communication device 220 may include at least one of a transmission antenna, a reception antenna, a radio frequency (RF) circuit for implementing various communication protocols, or an RF device for performing communication.

The communication device 220 may communicate with a device outside the vehicle 10 using a 5G (e.g., a new radio (NR)) method. The communication device 220 may implement V2X (V2V, V2D, V2P, and V2N) communication using the 5G method.

The driving manipulation device 230 may be used to receive a user command for driving the vehicle 10. In the manual mode, the vehicle 10 may travel based on a signal provided by the driving manipulation device 230. The driving manipulation device 230 may include a steering input device (e.g., a steering wheel), an acceleration input device (e.g., an acceleration pedal), and a brake input device (e.g., a brake pedal).

The main ECU 240 may control an overall operation of at least one electronic device included inside the vehicle 10.

The vehicle driving device 250 may be a device that electrically controls various vehicle driving devices in the vehicle 10. The vehicle driving device 250 may include a power train driving control device, a chassis driving control device, a door/window driving control device, a safety device driving control device, a lamp driving control device, and an air conditioner driving control device. The power train driving control device may include a power source driving control device and a transmission driving control device. The chassis driving control device may include a steering driving control device, a brake driving control device, and a suspension driving control device.

The safety device driving control device may include a safety belt driving control device for control of safety belt.

The vehicle driving device 250 may also be referred to as a control electronic control unit (ECU).

A traveling system 260 may generate a signal for controlling the movement of the vehicle 10 or for outputting information to a user, based on the data of the object, which is received from the object detection device 210. The traveling system 260 may provide the generated signal to at least one of the user interface device 200, the main ECU 240, or the vehicle driving device 250.

The traveling system 260 may conceptually include an advanced driver assistance system (ADAS). The ADAS 260 may implement at least one of an adaptive cruise control (ACC) system, an autonomous emergency braking (AEB) system, a forward collision warning (FCW) system, a lane keeping assist (LKA) system, a lane change assist (LCA) system, a target following assist (TFA) system, a blind spot detection (BSD) system, a high beam assist (HBA) system, an auto parking system (APS), a PD collision warning system, a traffic sign recognition (TSR) system, a traffic sign assist (TSA) system, a night vision (NV) system, a driver status monitoring (DSM) system, or a traffic jam assist (TJA) system.

The traveling system 260 may include autonomous driving electronic control unit (ECU). The autonomous driving ECU may set an autonomous driving route based on data received from at least one of other electronic devices in the vehicle 10. The autonomous driving ECU may set an autonomous driving route based on data received from at least one of the user interface device 200, the object detection device 210, the communication device 220, the sensing unit 270, or the position data generating device 280. The autonomous driving ECU may generate a control signal to enable the vehicle 10 to travel along an autonomous driving route. The control signal generated by the autonomous driving ECU may be provided to at least one of the main ECU 240 or the vehicle driving device 250.

The sensing unit 270 may sense a vehicle state. The sensing unit 270 may include at least one of an inertial navigation unit (IMU) sensor, a collision sensor, a wheel sensor, a speed sensor, an inclination sensor, a weight detection sensor, a heading sensor, a position module, a vehicle drive/reverse sensor, a battery sensor, a fuel sensor, a tire sensor, a steering sensor for rotation of the steering wheel, an in-vehicle temperature sensor, an in-vehicle humidity sensor, an ultrasonic sensor, an illuminance sensor, an acceleration pedal position sensor, or a brake pedal position sensor. The inertial navigation unit (IMU) sensor may include one or more of an acceleration sensor, a gyro sensor, and a magnetic sensor.

The sensing unit 270 may generate state data of a vehicle based on a signal generated by at least one sensor. The sensing unit 270 may acquire a sensing signal of vehicle position information, vehicle motion information, vehicle yaw information, vehicle roll information, vehicle pitch information, vehicle collision information, vehicle heading information, vehicle angle information, vehicle speed information, vehicle acceleration information, vehicle inclination information, vehicle drive/reverse information, battery information, fuel information, wheel information, vehicle lamp information, vehicle internal temperature information, vehicle internal humidity information, a steering wheel rotation angle, a vehicle external illuminance, the pressure applied to an accelerator pedal, the pressure applied to a brake pedal, and so on.

The sensing unit 270 may further include an accelerator pedal sensor, a pressure sensor, an engine speed sensor, an air flow sensor (AFS), an air temperature sensor (ATS), a water temperature sensor (WTS), a throttle position sensor (TPS), a top dead center (TDC) sensor, a crank angle sensor (CAS), and so on.

The sensing unit 270 may generate vehicle state information based on the sensing data. The vehicle state information may be generated based on data detected by various sensors included in the vehicle.

For example, the vehicle state information may include vehicle position information, vehicle speed information, vehicle inclination information, vehicle weight information, vehicle heading information, vehicle battery information, vehicle fuel information, vehicle wheel air pressure information, vehicle steering information, in-vehicle temperature information, in-vehicle humidity information, pedal position information, vehicle engine temperature information, and so on.

The sensing unit may include a tension sensor. The tension sensor may generate a sensing signal based on a tension state of a safety belt.

The position data generating device 280 may generate position data of the vehicle 10. The position data generating device 280 may include at least one of a global positioning system (GPS) or a differential global positioning system (DGPS). The position data generating device 280 may generate position data of the vehicle 10 based on a signal generated by at least one of a GPS or a DGPS. In some embodiments, the position data generating device 280 may correct the position data based on at least one of an inertial measurement unit (IMU) of the sensing unit 270 or a camera of the object detection device 210.

The position data generating device 280 may be referred to as a position displacement device. The position data generating device 280 may be referred to as a global navigation satellite system (GNSS).

The vehicle 10 may include an internal communication system 50. A plurality of electronic devices included in the vehicle 10 may exchange signals using the internal communication system 50 as a medium. The signals may include data. The internal communication system 50 may use at least one communication protocol (e.g., CAN, LIN, FlexRay, MOST, or Ethernet).

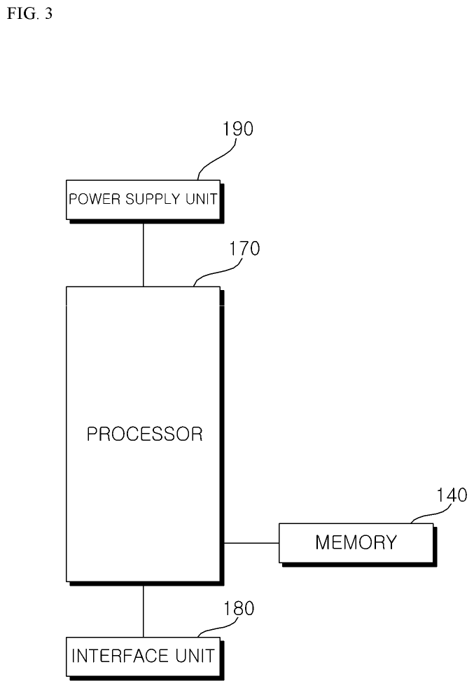

FIG. 3 is a control block diagram of an electronic device according to an embodiment of the present disclosure.

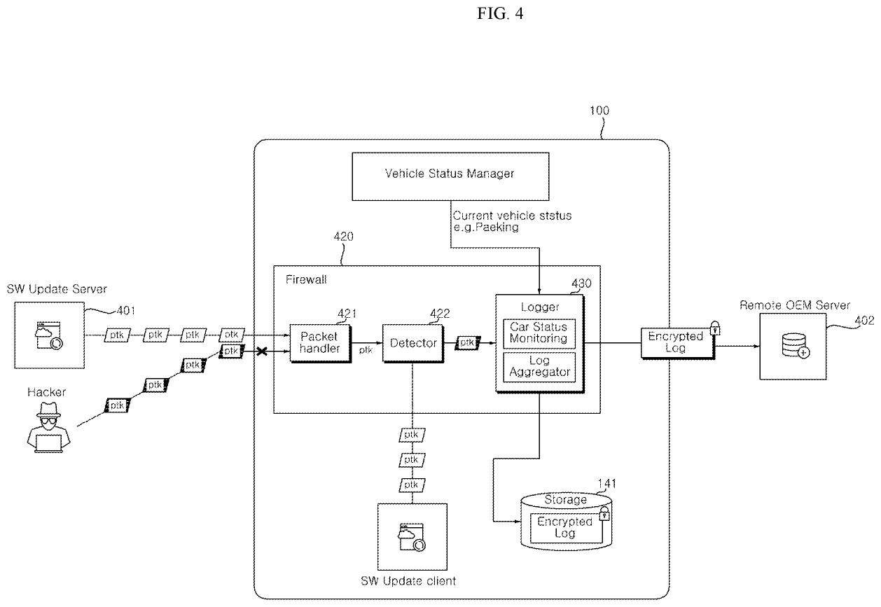

FIG. 4 is a diagram for explanation of a vehicular firewall provision device according to an embodiment of the present disclosure.

Referring to the drawings, the vehicular firewall provision device 100 may include a memory 140, a processor 170, an interface unit 180, and a power supply 190.

The memory 140 may be electrically connected to the processor 170. The memory 140 may store basic data of a predetermined unit, control data for control of an operation of a predetermined unit, and input and output data. The memory 140 may store data processed by the processor 170. The memory 140 may include at least one of a read-only memory (ROM), random-access memory (RAM), erasable programmable read only memory (EPROM), flash drive, or hard drive in terms of hardware. The memory 140 may store various data for an overall operation of the vehicular firewall provision device 100, such as a program for processing or controlling the processor 170. The memory 140 may be integrated into the processor 170. In some embodiments, the memory 140 may be classified as a lower-ranking component of the processor 170.

The interface unit 180 may exchange signals with the at least one electronic device included in the vehicle 10 in a wired or wireless manner. The interface unit 180 may exchange signals with at least one of the user interface device 200, the object detection device 210, the communication device 220, the driving manipulation device 230, the main ECU 240, the vehicle driving device 250, the traveling system 260, the sensing unit 270, or the position data generating device 280 in a wired or wireless manner. The interface unit 180 may configure at least one of a communication module, a terminal, a pin, a cable, a port, a circuit, an element, or a device.

The power supply 190 may supply power to the vehicular firewall provision device 100. The power supply 190 may receive power from a power source (e.g., a battery) included in the vehicle 10 and may supply power to each unit of the firewall provision device 100. The power supply 190 may be operated according to a control signal provided from the main ECU 240. The power supply 190 may be embodied as a switched-mode power supply (SMPS).

The processor 170 may be electrically connected to the memory 140, the interface unit 180, and the power supply 190 and may exchange a signal therewith. The processor 170 may be embodied using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or an electronic unit for performing other functions.

The processor 170 may be driven by power supplied from the power supply 190. The processor 170 may receive data, may process the data, may generate a signal, and may provide a signal in a state in which power is supplied by the power supply 190.

The processor 170 may receive information from other electronic devices within the vehicle 10 through the interface unit 180. The processor 170 may provide a control signal to other electronic devices within the vehicle 10 through the interface unit 180.

The processor 170 may match a data packet received from an external device 401 and a plurality of rules. The external device may be any one of a server, other vehicles, and a terminal.

The plurality of rules may be made and set by a user. The plurality of rules may be generated based on an Internet protocol (IP) address and a port. The plurality of rules may include a black list rule and a white list rule. The black list rule may be generated based on an IP address and a port. The black list rule may be defined as a list of a data packet excluded from a processing target. The white list rule may be generated based on an IP address and a port. The white list rule may be defined as a list of a data packet included in a processing target.

When data throughput of at least one electronic device included in the vehicle 10 is equal to or greater than a reference value, the processor 170 may temporally store a plurality of pieces of log data of a plurality of data packets that are dropped according to at least one of a plurality of rules.

The processor 170 may encrypt the plurality of pieces of log data that are temporally stored when the data throughput is less than the reference value.

The processor 170 may include a user space 420. The user space 420 may be defined as a space in which an application is executed. Here, the application may be a firewall application.

The firewall application 420 may include a packet handler 421, a detector 422, and a logger 430.

The packet handler 421 may receive a plurality of data packets. The packet handler 421 may decode the received data packet.

The detector 422 may filter a data packet based on a plurality of rules among the plurality of data packets. The detector 422 may filter the packet received through the packet handler 421 based on at least one of a black list rule or a white list rule. For example, the detector 422 may filter a data packet by performing pattern matching on a complicated type of stream such as an IP address, a port, and payload regular expressions based on the black list rule and the white list rule.

The logger 430 may collect a plurality of pieces of log data of the plurality of dropped data packets.

The logger 430 may receive vehicle status information from a vehicle status manager 440. For example, the logger 430 may receive information on data throughput of at least one electronic device included in the vehicle 10, from the vehicle status manager 440.

When the amount of data received from an external device is equal to or greater than a reference value, the logger 430 may temporally store a plurality of pieces of log data of a plurality of data packets dropped by at least one of the plurality of rules. When the amount of data received from an external device is less than the reference value, the logger 430 may encrypt the plurality of pieces of log data that are temporally stored.

Upon detecting hacking attacks, the logger 430 may temporally store a plurality of pieces of log data of a plurality of data packets dropped by at least one of a plurality of rules. When hacking attacks are terminated, the logger 430 may encrypt the plurality of pieces of log data that are temporally stored.

When the amount of data generated about an object outside the vehicle 10 is equal to or greater than a reference value, the logger 430 may temporally store a plurality of pieces of log data of a plurality of data packets dropped by at least one of a plurality of rules. When the amount of data generated about the object outside the vehicle 10 is less than the reference value, the logger 430 may encrypt the plurality of pieces of log data that are temporally stored.

The logger 430 may aggregate and temporally store the plurality of pieces of log data. For example, the logger 430 may aggregate and temporally store the plurality of pieces of log data for a plurality of respective identifications (IDs).

Each of the plurality of pieces of log data may include at least one of a generation time, an IP address, a port, or a protocol. The generation time may be a time point at which a data packet is dropped according to any one of a plurality of rules. The IP address may be an IP address to which the dropped data packet is transmitted. The port may be a port to which the dropped data packet is transmitted. The protocol may be a communication protocol may be a communication protocol of the dropped data packet.

The logger 430 may aggregate a plurality of pieces of log data and may temporally store the aggregated log data in a buffer. The buffer may be one region allocated to a memory 140. The buffer may be a memory region allocated to the inside of the processor 170.

When the volume of the plurality of aggregated pieces of log data exceeds the capacity of the buffer, the logger 430 may store the plurality of aggregated pieces of log data in a storage 141. The storage may be one region allocated to a hard disk included in the vehicle.

The processor 170 may retrieve the plurality of aggregated pieces of log data. The processor 170 may encrypt the plurality of retrieved pieces of log data.

In some embodiments, the processor 170 may encrypt the plurality of aggregated pieces of log data.

The processor 170 may transmit the plurality of encrypted log data to an external server 402. For example, the processor 170 may transmit the plurality of encrypted log data in the retrieved state to the external server 402. In this case, the external server 402 may decode and use the plurality of encrypted log data. For example, the processor 170 may transmit the plurality of encrypted pieces of log data in the aggregate stage to the external server 402. In this case, after decoding the plurality of pieces of log data, the external server 402 may retrieve and use the plurality of pieces of log data.

The firewall provision device 100 may include at least one printed circuit board (PCB). The memory 140, the interface unit 180, the power supply 190, and the processor 170 may be electrically connected to the PCB.

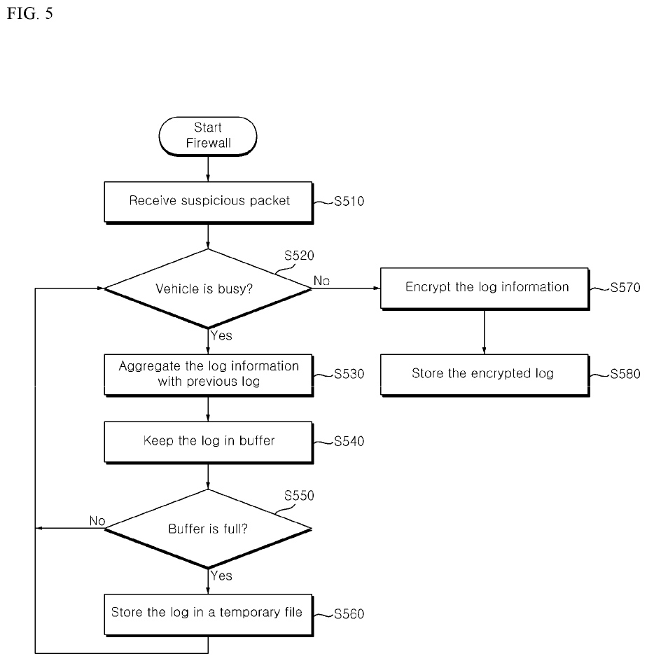

FIG. 5 is a diagram for explanation of an operation of a vehicular firewall provision device according to an embodiment of the present disclosure.

Referring to FIGS. 4 and 5, the processor 170 may receive a plurality of data packets from the external device 401 (S510). The processor 170 may match the plurality of data packets and a plurality of rules (S510).

The processor 170 may determine whether data throughput of at least one electronic device included in the vehicle 10 is equal to or greater than a reference value (S520).

Upon determining that data throughput of at least one electronic device included in the vehicle 10 is equal to or greater than a reference value, the processor 170 may aggregate a plurality of pieces of log data (S530).

The processor 170 may temporally store the plurality of aggregated pieces of log data in a buffer (S540). Upon determining that data throughput of at least one electronic device included in the vehicle 10 is equal to or greater than a reference value, the processor 170 may temporally store a plurality of pieces of log data of a plurality of data packets dropped according to at least one of a plurality of rules.

The processor 170 may determine the volume of the plurality of aggregated pieces of log data exceeds the capacity of the buffer (S550).

Upon determining that the volume of the plurality of aggregated pieces of log data exceeds the capacity of the buffer, the processor 170 may store the plurality of aggregated pieces of log data in the storage 141 (S560).

In operation S550, upon determining that the volume of the plurality of aggregated pieces of log data does not exceed the capacity of the buffer, the processor 170 may perform operation S520.

After operation S560, the processor 170 may perform operation S520.

In operation S520, when data throughput of at least one electronic device included in the vehicle 10 is less than a reference value, the processor 170 may encrypt the plurality of pieces of log data that are temporally stored (S570).

The encryption operation S570 may include retrieving the plurality of aggregated pieces of log data by the at least one processor 170 and encrypting the plurality of retrieved pieces of log data by the at least one processor 170.

The encryption operation S570 may include encrypting the aggregated pieces of log data by the at least one processor 170.

Then, the processor 170 may store the encrypted log data (S580).

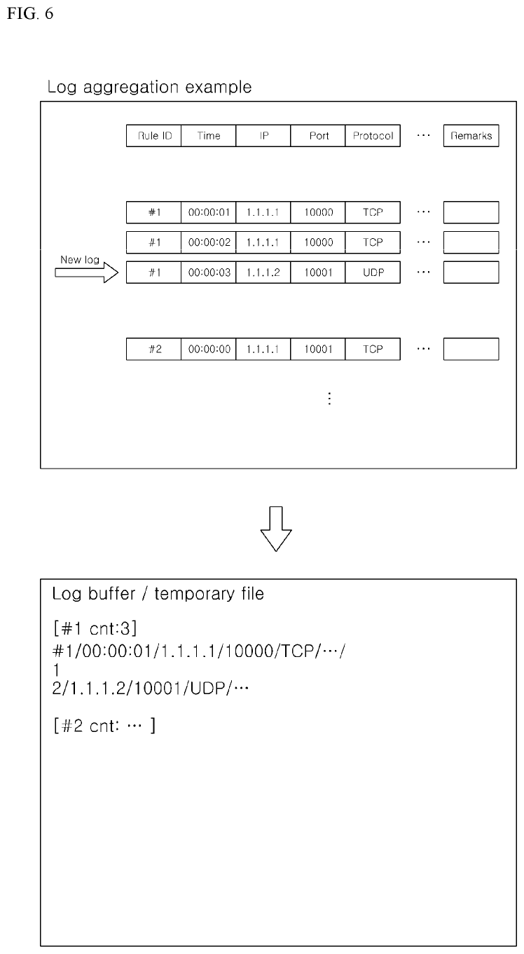

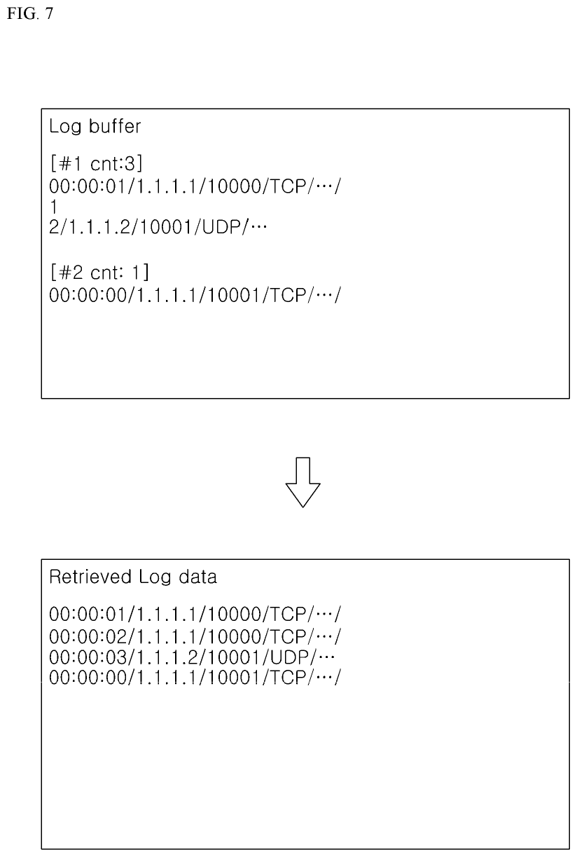

FIGS. 6 and 7 are diagrams for explanation of an operation of a vehicular firewall provision device according to an embodiment of the present disclosure.

Referring to FIG. 6, the processor 170 may align log data of dropped packets for respective rule IDs (610). The log data may include at least one of a generation time, an IP address, a port, or a protocol.

When the plurality of pieces of log data of the dropped packets is the same, the processor 170 may increase a count rather than separately recording the data. For example, the processor 170 may record a generation time, an IP address, a port, and a protocol of first log data. When second log data that is the same as the first log data is generated, the processor 170 may increase a count on the recorded first log data rather than separately recording the second log data.

When the plurality of pieces of log data of the dropped packets is different, the processor 170 may record only a different item. For example, the processor 170 may recode a generation time, an IP address, a port, and a protocol of the first log data. When the second log data, a generation time of which is different from the first log data but the other items of which is the same as the first log data, is generated, the processor 170 may record only the generation time of the second log data.

When a determined capacity of the buffer is larger than the volume of transmitted log information, the processor 170 may move the log information as a temporal file to a storage and may store the log information in the storage.

When the buffer is full of data, the processor 170 may the entire log data to the storage.

When log data matching a specific rule ID is not generated for a predetermined time period, the processor 170 may move only the log data matching the specific rule ID to the storage.

When a large amount of log data matching the specific rule ID is generated for a short time, the processor 170 may move the entire log data except for the log data matching the corresponding rule ID to the storage.

Referring to FIG. 7, the aggregated log data may be retrieved by the vehicular firewall provision device 100. When data throughput of at least one electronic device included in the vehicle 10 is less than a reference value, the processor 170 may retrieve the aggregated log data before the log data is encrypted. In this case, an external server may be advantageously prevented from being overloaded with retrieval of a large amount of log data of a vehicle. In addition, an external server may be advantageously prevented from being overloaded with selection of log of a vehicle having a corresponding function installed therein.

The aggregated log data may be retrieved by a data center (external server). The external server may decode the encrypted log data in the aggregated state and then may retrieve the log data. In this case, a resource of a vehicle may not be advantageously used. In addition, the amount of data to be transmitted may be advantageously reduced.

The external server may make a request to a plurality of vehicles for retrieval of log data according to a policy or a situation of the server. The requested vehicle 10 may retrieve, may encrypt, and then may store log data that is generated and aggregated after the request. The retrieved and encrypted data may be stored as a different data from the original data to thus prevent confusion. According to the request of the external server, log data stored in the vehicle 10 may be transmitted. The external server may retrieve only some data that is not retrieved. For example, the external server may receive data that is retrieved and then encrypted from a first vehicle and may receive the encrypted data in the aggregated state from a second vehicle. In this case, the external server may simply decode the data received from the first vehicle to ensure the log data. The external server may decode and then retrieve the data received from the second vehicle to ensure the log data.

When a policy or a situation of the external server is changed, the external server may make a request to each vehicle for stoppage of retrieval of the log data.

The present disclosure can also be embodied as computer readable code on a computer readable recording medium. The computer readable recording medium is any data storage device that can store data which can be thereafter read by a computer system. Examples of the computer readable recording medium include hard disk drive (HDD), solid state disk (SSD), silicon disk drive (SDD), ROM, RAM, CD-ROM, magnetic tapes, floppy disks, optical data storage devices, etc. and include a carrier wave (for example, a transmission over the Internet). In addition, the computer may include a processor or a controller. Accordingly, it will be apparent to those skilled in the art that various modifications and variations can be made in the present disclosure without departing from the spirit or scope of the disclosure. Thus, it is intended that the present disclosure cover the modifications and variations of the disclosure provided they come within the scope of the appended claims and their equivalents.

### DESCRIPTION OF REFERENCE NUMERALS

10: vehicle

100: vehicular firewall provision device

What is claimed is:

1. A vehicular firewall provision device comprising:
a processor configured to:
match a data packet received from an external device with a plurality of rules,
temporally store a plurality of pieces of log data of a plurality of data packets that are dropped according to at least one of the plurality of rules, when data throughput of at least one electronic device included in a vehicle is equal to or greater than a reference value, and
encrypt the plurality of pieces of log data that are temporally stored, when the data throughput is less than the reference value.

2. The vehicular firewall provision device of claim 1, further comprising:
a packet handler configured to receive the plurality of data packets;
a detector configured to filter a data packet based on the plurality of rules among the plurality of data packets; and
a logger configured to collect a plurality of pieces of log data of the plurality of data packets that are dropped.

3. The vehicular firewall provision device of claim 2, wherein the logger is configured to:
when an amount of data received from the external device is equal to or greater than a reference value, temporally store the plurality of pieces of log data of the plurality of data packets that are dropped according to at least one of the plurality of rules, and
when the amount of data received from the external device is less than the reference value, encrypt the plurality of pieces of log data that are temporally stored.

4. The vehicular firewall provision device of claim 2, wherein the logger is configured to:
when hacking attacks are detected, temporally store the plurality of pieces of log data of the plurality of data packets that are dropped according to at least one of the plurality of rules, and
when the hacking attacks are terminated, encrypt the plurality of pieces of log data that are temporally stored.

5. The vehicular firewall provision device of claim 2, wherein the logger configured to:
when an amount of data generated about an object outside the vehicle is equal to or greater than a reference value, temporally store the plurality of pieces of log data of the plurality of data packets that are dropped according to at least one of the plurality of rules, and
when the amount of data generated about the object outside the vehicle is less than the reference value, encrypt the plurality of pieces of log data that are temporally stored.

6. The vehicular firewall provision device of claim 2, wherein the logger is configured to aggregate and temporally store the plurality of pieces of log data.

7. The vehicular firewall provision device of claim 6, wherein the logger is configured to aggregate and temporally store the plurality of pieces of log data for respective identifications (IDs) of the plurality of rules.

8. The vehicular firewall provision device of claim 6, wherein each of the plurality of pieces of log data includes at least one of a generation time, an internet protocol (IP) address, a port, or a protocol.

9. The vehicular firewall provision device of claim 6, wherein the logger is configured to:
aggregate the plurality of pieces of log data and temporally store the plurality of pieces of log data in a buffer, and
when a capacity of the buffer is exceeded, store the plurality of pieces of log data that are aggregated in a storage.

10. The vehicular firewall provision device of claim 6, wherein the processor is configured to retrieve the plurality of pieces of log data that are aggregated and encrypt the plurality of pieces of log data that are retrieved.

11. The vehicular firewall provision device of claim 6, wherein the processor is configured to encrypt the plurality of pieces of log data that are aggregated.

12. The vehicular firewall provision device of claim 1, wherein the plurality of rules includes:
a black list rule generated based on an internet protocol (IP) address and a port, the black list rule defined as a list of a data packet excluded from a processing target; and
a white list rule generated based on an IP address and a port, the white list defined as a list of a data packet included in the processing target.

13. An operation method of a vehicular firewall provision device, the method comprising:
receiving, by at least one processor, a plurality of data packets from an external device;
matching, by the at least one processor, the plurality of data packets with a plurality of rules;
temporally storing, by the at least one processor, a plurality of pieces of log data of a plurality of data packets that are dropped according to at least one of the plurality of rules, when data throughput of at least one electronic device included in a vehicle is equal to or greater than a reference value; and
encrypting, by the at least one processor, the plurality of pieces of log data that are temporally stored, when the data throughput is less than the reference value.

14. The method of claim 13, further comprising:
aggregating and temporally storing, by the at least one processor, the plurality of pieces of log data.

15. The method of claim 14, wherein the encrypting includes:
retrieving, by the at least one processor, the plurality of pieces of log data that are aggregated; and
encrypting, by the at least one processor, the plurality of pieces of log data that are retrieved.

16. The method of claim 14, wherein the encrypting includes encrypting, by the at least one processor, the plurality of pieces of log data that are aggregated.
